(19) United States
(12) Patent Application Publication
(10) Pub. No.: US 2008/0245180 A1
(43) Pub. Date: Oct. 9, 2008

(54) ASSEMBLY STRUCTURE OF TREADING CRANK AND SPINDLE TUBE OF THE BIKE

(76) Inventor: Yuan-Hsin Huang, Yongjing Township (TW)

Correspondence Address: RABIN & BERDO, P.C., Suite 500, 1101 14th Street, N.W., Washington, DC, 20005, US

(21) Appl. No.: 11/697,788

(22) Filed: Apr. 9, 2007

(51) Int. Cl. G05G 1/14

(52) U.S. Cl. 74/594.1

(57) ABSTRACT

The invention relates to an assembly structure of treading crank and spindle tube of the bike; wherein circularly set several convex straight ribs, with even intervals, on the inner surface of the treading crank, and there is a reserved circular space between each convex straight rib and the bottom surface of the central hole. Several circularly arranged sunken-shaped cavernous-straight troughs are set on the section of the end surface; when combining treading crank and spindle tube, make use of a suitable size of cone-expanding body and set the big bottom of said cone-expanding body at the bottom surface; then push said several cavernous-straight troughs set on the end surface of the spindle tube toward the direction of the section the convex straight ribs; said several cavernous-straight troughs will move outwardly and into the circular space between convex straight rib and the bottom surface and then to be locked.

### BACKGROUND OF THE INVENTION

1) Field of the Invention

The invention relates to an assembly structure of treading crank and spindle tube of the bike; the main purpose of the invention is to provide a method for fast fabricating the treading crank and the spindle tube of the bike to the destined position completely and stably.

2) Description of the Related Art

Normally, the fabrication of treading crank and spindle tube is (as shown in FIGS. 1-A and 1-B): to make a passing-through-inside-and-outside stairway-tooth-shaped hole B1 at the intermediate position of treading crank B of bike body A and set a convex loop-fringe C1 on one end of spindle tube C; in addition, circularly set several convex straight-parts C2 at the outer surface of convex loop-fringe C1 and the tube with even interval. Hence, when treading crank B and spindle tube C are combined, firstly, said spindle tube C, via the other end, penetrates through stairway-tooth-shaped hole B1 of treading crank B; then, make convex loop-fringe C1 and several convex straight-parts C2 nestle to inside of the stairway-tooth-shaped hole B1 of treading crank B for closely combining treading crank B and spindle tube C (as shown in FIG. 2 and FIG. 4); after that, fabricate said combined pieces on bike body A to be assembled with tooth-disc (as shown in FIG. 3). However, such closely jointing method will result in an assembled mark and affect esthetic appearance, since stairway-tooth-shaped hole B1, at the intermediate part of treading crank B, is shaped as an inside-and-outside passing-through hole. Furthermore, hit by external force will easily cause the possibility of displacing treading crank B while being applied (as shown in FIG. 4). Hence, the stoutness and safety of the assembly would be suffered question, and need to be solved thoroughly.

### SUMMARY OF THE INVENTION

The major purpose of the invention is providing an assembly structure of treading crank and spindle tube of the bike; wherein, circularly set several convex straight ribs, with even intervals, on the inner surface of the central hole of the treading crank, and there is a reserved circular space between each convex straight rib and the bottom surface of the central hole. Moreover, several circularly arranged sunken-shaped cavernous-straight troughs are set on the section of the end surface of the spindle tube; when combining treading crank and spindle tube, make use of the action of the small-top-and-big-bottom cone-expanding body set between both said pieces to drive said several cavernous-straight troughs on the end surface of the spindle tube to move outwardly into the circular space between convex straight rib and the bottom surface of the central hole of the treading crank to be locked for achieving the purpose of fast fabricating a completely stable and well-positioned combination.

### BRIEF DESCRIPTION OF THE DRAWINGS

Other features and advantages of the invention will become apparent in the following detailed description of the preferred embodiments, with reference to the accompanying drawings, in which:

FIG. 1-A is a schematic view of the conventional structure.

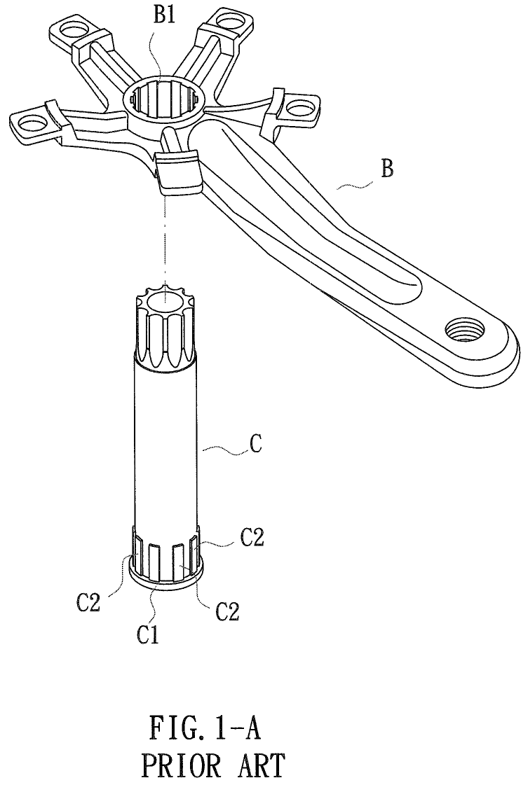

FIG. 1-B is a schematic view of the assembled conventional structure.

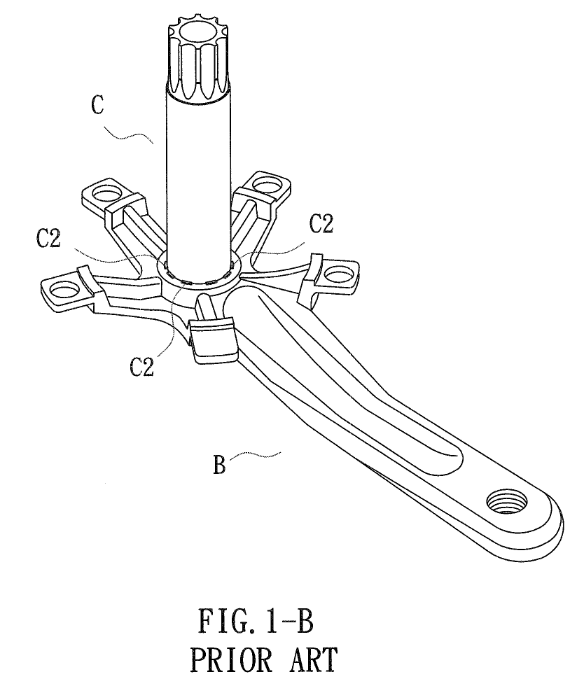

FIG. 2 is a 3-D view of the assembled conventional structure.

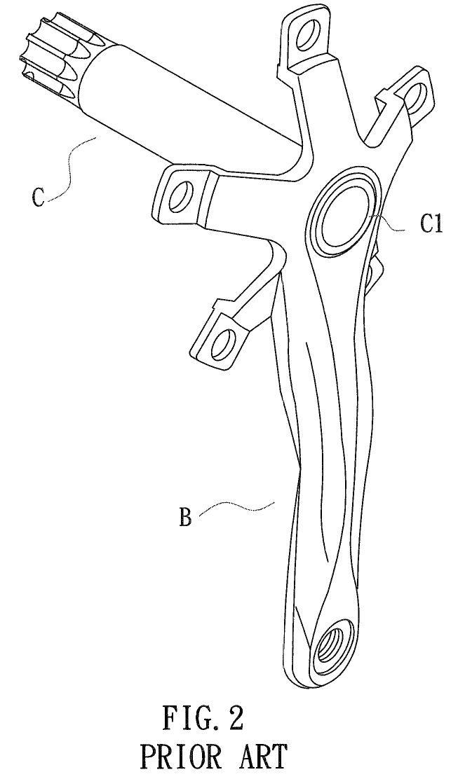

FIG. 3 is a schematic view of the assembling position of the conventional structure.

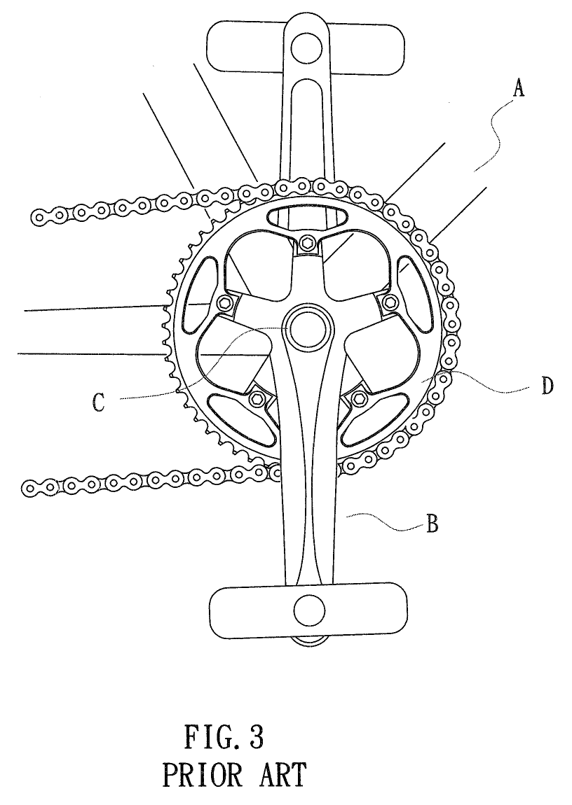

FIG. 4 is a cross-section view of the assembled conventional structure.

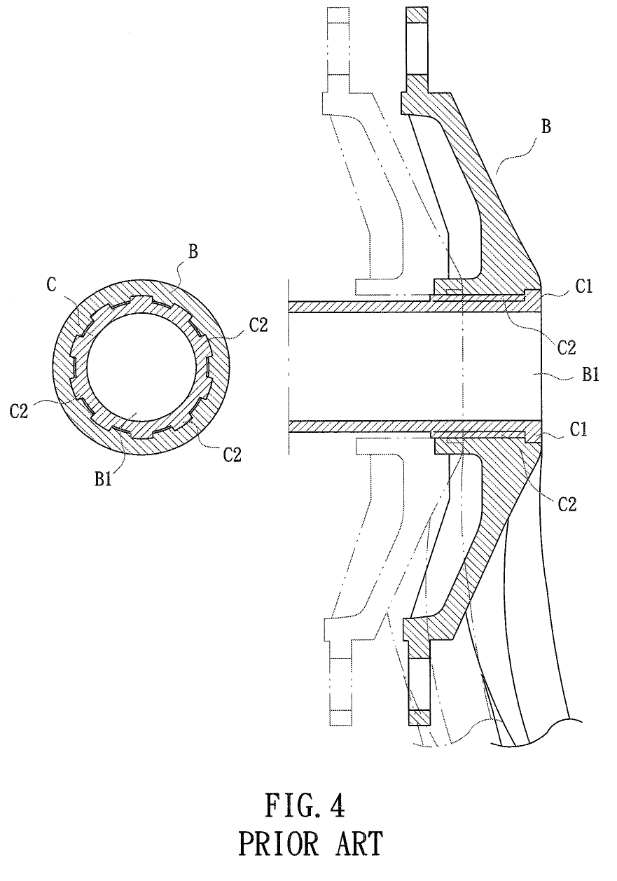

FIG. 5-A is a schematic view (1) of the structure and assembly of the invention.

FIG. 5-B is a schematic view (2) of the structure and assembly of the invention.

FIG. 6-A is a schematic view (1) of the assembly of the invention.

FIG. 6-B is a schematic view (2) of the assembly of the invention.

FIG. 7 is an assembled 3-D view of the invention.

FIG. 8 is a schematic view of the assembling position of the invention.

### DETAILED DESCRIPTION OF THE PREFERRED EMBODIMENTS

In the detailed description of the preferred embodiments, it should be noted that like elements are indicated by the same reference numerals throughout the disclosure.

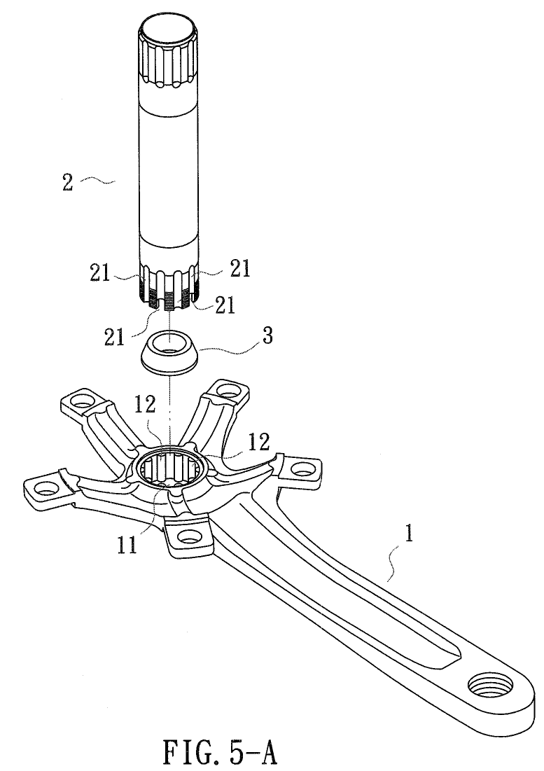

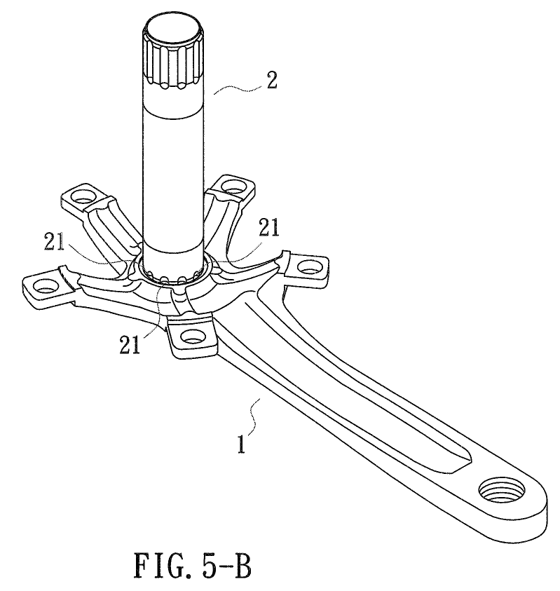

Firstly, please refer to FIG. 5-A, and FIG. 5-B. The invention relates to an assembly structure of treading crank and spindle tube of the bike and aimed at those whose treading crank 1 for being treaded is combined with spindle tube 2 of bike body A. Central sunken-shaped hole 11 is set at the intermediate position of the treading crank 1 and convex straight rib 12 section is circularly set on the inner surface of the central hole 11 with even intervals; moreover, there is a reserved circular space 13 between each convex straight rib 12 and the bottom surface of the central hole 11, and several circularly arranged sunken-shaped cavernous-straight troughs 21 are set on the section of the end surface of the spindle tube 2. In addition, the appearance of the cone-expanding body 3 is shaped as small diameter on top and large diameter on bottom.

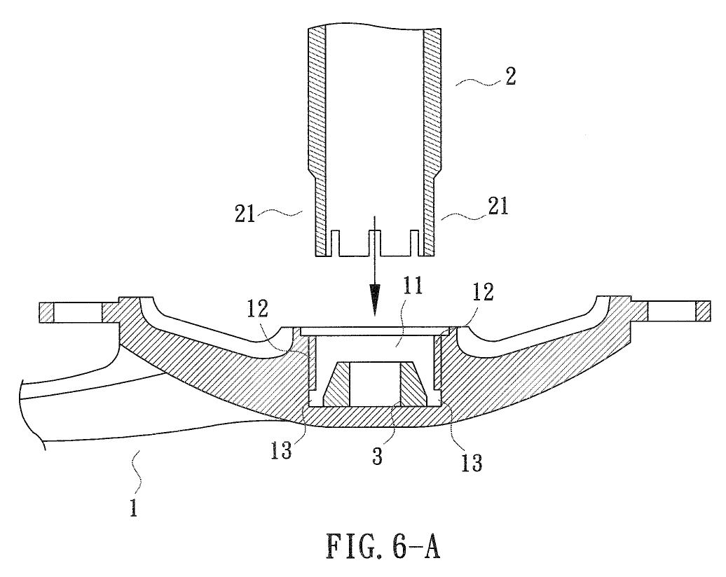

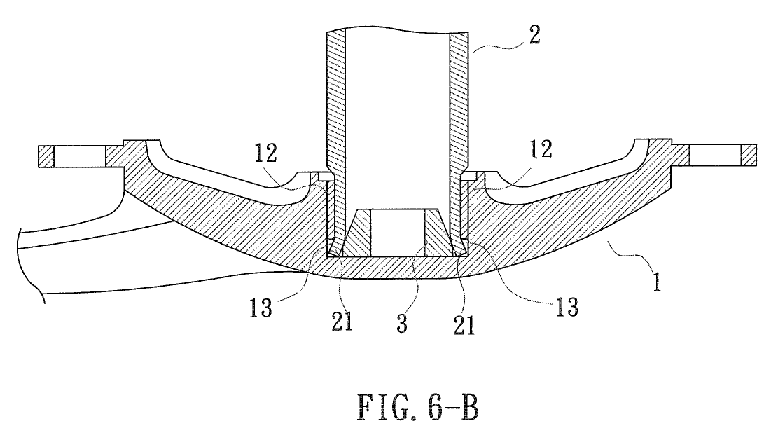

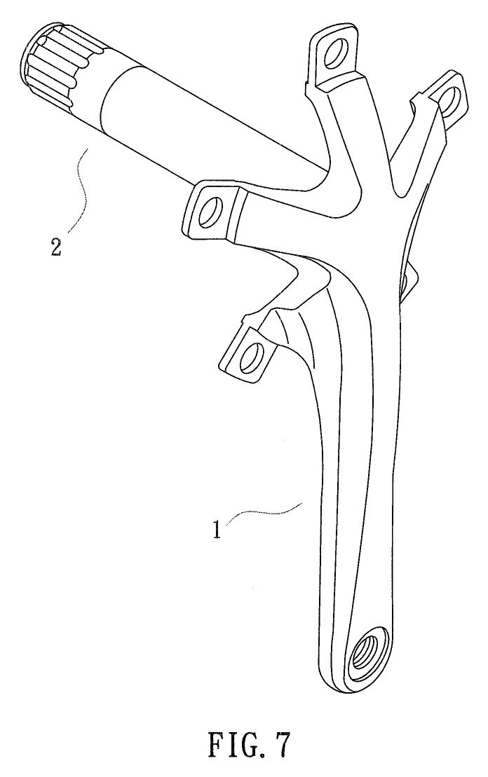

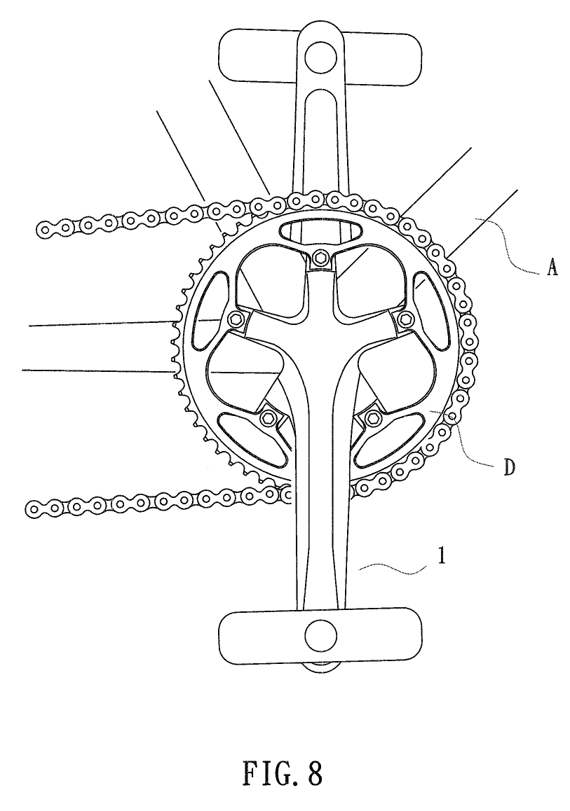

Hence, when combining treading crank 1 and spindle tube 2, set the large diameter bottom part of cone-expanding body 3 at the bottom surface of central hole 11 of treading crank 1, and then push several cavernous-straight troughs 21 set on the end surface of the spindle tube 2 toward the direction of the section of convex straight rib 12 of central hole 11 of treading crank 1; since cone-expanding body 3 is set at the position of small diameter on top and large diameter on bottom, several cavernous-straight troughs 21 on the end surface of the spindle tube 2 will move outwardly and into the circular space 13 between convex straight rib 12 and the bottom surface of the central hole 11 to be locked (as shown in FIG. 6-A, and FIG. 6-B), when gradually touching the small-top-and-big-bottom appearance of cone-expanding body 3. Hence, the purpose of assuring the completely stable and well-positioned combination is achieved (as shown in FIG. 7); then, assemble the assembled component onto bike body A and assemble it with tooth disc D (as shown in FIG. 8).

While the description of present invention is made in connection with what is considered the most practical and preferred embodiments, it is understood that this invention is not limited to the disclosed embodiments but intended to cover various arrangements included within the spirit and scope of the broadest interpretations and equivalent arrangements.

What is claimed is:

1. The invention relates to an assembly structure of treading crank and spindle tube of the bike and aimed at those whose treading crank for being treaded is combined with the spindle tube; the central sunken-shaped hole is set at the intermediate position of the treading crank and convex straight ribs are circularly set on the inner surface of the central hole with even intervals; moreover, there is a reserved circular space between each convex straight rib and the bottom surface of the central hole; several circularly arranged sunken-shaped cavernous-straight troughs are set on the section of the end surface of the spindle tube; a cone-expanding body is shaped as small diameter on top and large diameter on bottom; when combining treading crank and spindle tube, make use of the action of the small-top-and-big-bottom cone-expanding body located between both said pieces and set the big bottom of said cone body at the bottom surface of said central hole of said treading crank; then push on the section of toward the direction of the section the convex straight ribs of the central hole of the treading crank; since the cone-expanding body is set at the position of small top and big bottom, said several cavernous-straight troughs set on the end surface of the spindle tube will move outwardly and into the circular space between convex straight rib and the bottom surface of the central hole of the treading crank and then to be locked; hence, the purpose of fast fabricating a completely stable and well-positioned combination is achieved.
